(19) United States
(12) Patent Application Publication
(10) Pub. No.: US 2016/0085397 A1
(43) Pub. Date: Mar. 24, 2016

(54) Smart Watch Notification Manager

(71) Applicant: QUALCOMM Incorporated, San Diego, CA (US)

(72) Inventor: Nikhil JAIN, San Diego, CA (US)

(21) Appl. No.: 14/622,207

(22) Filed: Feb. 13, 2015

Related U.S. Application Data
(60) Provisional application No. 62/054,028, filed on Sep. 23, 2014.

(51) Int. Cl. G06F 3/0484; G06F 3/0482; G06F 3/0488; H04W 68/00

(52) U.S. Cl. CPC G06F 3/0484; H04W 68/005; G06F 3/0482; G06F 3/0488

(57) ABSTRACT

Systems, methods, and devices of the various embodiments enable the management of notifications on a small computing device. A processor may display a first notification of a plurality of notifications on substantially all of the small touchscreen of the computing device. The processor may temporarily dismiss the plurality of notifications when a first user input is received by the computing device. The processor may recall the plurality of notifications and display the first notification on substantially all of the small touchscreen when a second user input is received by the computing device. The processor may permanently dismiss the first notification when a third user input is received by the computing device. The processor may display a second notification of the plurality of notifications on substantially all of the small touchscreen of the computing device when the first notification is permanently dismissed.

### RELATED APPLICATIONS

This application claims the benefit of U.S. Provisional Patent Application 62/054,028 entitled “Smart Watch Notification Manager,” filed Sep. 23, 2014, the entire contents of which are hereby incorporated by reference for all purposes.

### BACKGROUND

Miniaturization of advanced electronics has made possible very small displays, which may be used with wearable electronics, such as wrist-worn displays (e.g., smart watches). Because the area of such a display is relatively small, to receive user inputs the small display is typically configured with a touch screen, and may also include a button or buttons on the body of the display.

Small displays may function as a second display for another device such as a smart phone. Notifications received by the phone or other device may be forwarded to the small display. Because of the relatively small display area, notifications on the small display may occupy a relatively large portion of the display area, and may obscure other information on the display. When a notification obscures other information, a user may interact with the notification to remove it, dismissing the notification permanently such that the information of the notification is lost. Because it may be difficult for a user to accurately touch the small screen area, reducing the size of notifications increases the difficulty of interacting with them.

### SUMMARY

Systems, methods, and devices of various embodiments enable a computing device to manage notifications on a small touchscreen of the computing device by displaying a first notification of a plurality of notifications on substantially all of the small touchscreen of the computing device, temporarily dismissing the plurality of notifications when a first user input is received by the computing device, recalling the plurality of notifications and displaying the first notification on substantially all of the small touchscreen of the device when a second user input is received by the computing device, permanently dismissing the first notification when a third user input is received by the computing device, and displaying a second notification of the plurality of notifications on substantially all of the small touchscreen of the device when the first notification is permanently dismissed.

In various embodiments, temporarily dismissing the plurality of notifications may include retaining the notifications in a memory of the computing device. In various embodiments, temporarily dismissing the plurality of notifications may include enabling access to another function of the computing device on substantially all of the small touchscreen of the computing device. In various embodiments, displaying a second notification of the plurality of notifications on substantially all of the small touchscreen of the computing device when the first notification is permanently dismissed may include displaying a decreasing portion of the first notification and an increasing portion of the second notification on substantially all of the small touchscreen of the computing device when the first notification is permanently dismissed. In various embodiments, the computing device may include a wrist-worn display, although the various embodiments may be applicable in a variety of electronic devices and computing devices including a variety of displays.

Various embodiments include a multi-subscription communication device including a processor configured with processor-executable instructions to perform operations of the embodiment methods described above. Various embodiments also include a non-transitory processor-readable storage medium having stored thereon processor-executable software instructions configured to cause a processor to perform operations of the embodiment methods described above. Various embodiments also include a multi-subscription communication device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments. Together with the general description given above and the detailed description given below, serve to explain the features of the various embodiments.

FIGS. 1-11 illustrate example displays on a small touchscreen of a device suitable for use with the various embodiments.

FIG. 12 is a state diagram illustrating embodiment states and state transitions of a computing device.

FIG. 13 is a process flow diagram illustrating an embodiment method for managing notifications on a small touchscreen of a device.

FIG. 14 is a component diagram of a computing device including a small touchscreen suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the various embodiments or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used herein to refer to any one or all of smart watches, wearable computers (e.g., computing devices in the form of a badge, tag, bracelet, patch, belt buckle, medallion, necklace, pendant, pen, key chain, or any other device worn or carried by a user), cellular telephones, smart phones, personal or mobile multi-media players, personal data assistants (PDAs), wireless electronic mail receivers, multimedia Internet enabled cellular telephones, wireless gaming controllers, and similar personal electronic devices that include one or more programmable processor, memory, and a touchscreen display or similar user interface for displaying characters and/or images. A computing device may also include a device with a small display that may be attached to or integrated with a small area of an appliance, furniture, on a small area of a vehicles (e.g., on motorcycles, bicycles, or cars), and on small hand-held computing devices such as tablets and smart phones. Because the area of such a display is relatively small, to receive user inputs the small display is typically configured with a touch screen, and may also include a button or buttons on the body of the display.

The systems, methods, and devices of the various embodiments enable the management of notifications displayed on a small screen of a computing device, particularly a touchscreen display with a size such that a notification may be displayed on substantially all of the touchscreen display. A “notification” refers to a message that may be presented to a user of a device to alert the user to the availability of a message (e.g., an email, a text message, or a voice message), a content update, an event within an application, or a device event. The notification may be distinct from the message, content update, application event, or device event. The notification may be stored in a memory of the computing device, and may include data representing an association with an application, such as a pointer, a link, a shortcut, or other associative information. In some embodiments, a processor of the computing device may launch the associated application when the computing device receives a user input to invoke the application through the notification.

One or more notifications may be stored in a memory of the computing device, and a first notification message may be displayed. In an embodiment, the one or more notifications may be temporarily dismissed when a first user input is received by the computing device, such that the notifications are stored in memory but are not displayed on the touchscreen display. When the notifications are temporarily dismissed, other functions of the computing device may be accessed without removing any of the notifications from memory. In an embodiment, a small notification may be displayed on a portion of the touchscreen display that one or more temporarily dismissed notifications remain in memory.

In an embodiment, the temporarily dismissed notifications may be recalled when another input is received by the computing device, and the first notification message may be displayed on the touchscreen display. When the first notification is displayed on substantially all of the touchscreen display, the computing device may receive a user input and the computing device may launch an application associated with the first notification. Alternatively, when the first notification is displayed, the computing device may receive another input and may permanently dismiss the first notification. The permanently dismissed notification may be removed from memory and may no longer be displayed on the touchscreen display. In an embodiment, when the first notification is permanently dismissed, a second notification, if one is present, may be displayed on substantially all of the touchscreen display. Alternatively, when the first notification is permanently dismissed and no other notifications are present, a main screen may be displayed on substantially all of the touchscreen display.

Inputs that the computing device may receive to manage notifications include a user tapping (i.e., a tap) on the touchscreen (e.g., by putting a finger down on the touchscreen and lifting it back off the touchscreen within a period of time), a user tapping and holding (i.e., a tap and hold) on the touchscreen for a period of time (e.g., by putting a finger down on the touchscreen and leaving the finger depressed on the touchscreen for a period of time), a user tapping twice (i.e., a double tap) within a period of time (e.g., by repeating a tap in the same portion of the touchscreen in quick succession), a user swiping (i.e., a swipe) the touchscreen (e.g., by dragging a finger across a portion of the touchscreen), a user pressing one or more buttons disposed on a body of the computing device (which may be push buttons, capacitive switches, or another physical device to receive a user input), voice or other audible input, or any other user input to the touchscreen or to a button or other portion of the computing device. The computing device may also include one or more sensors capable of detecting movements of fingers, hands, muscles, or tendons on a user's body and/or spatial movements of the computing device itself. The computing device may also include one or more sensors capable of detecting one or more bionic inputs based on signals produced by a user's body, such as muscle or tendon flexures, nerve-related electrical signals, brain wave patterns, changes in galvanic skin response, and thermal emissions. A processor of the computing device may analyze and correlate certain detected movements and/or signals with inputs to manage notifications.

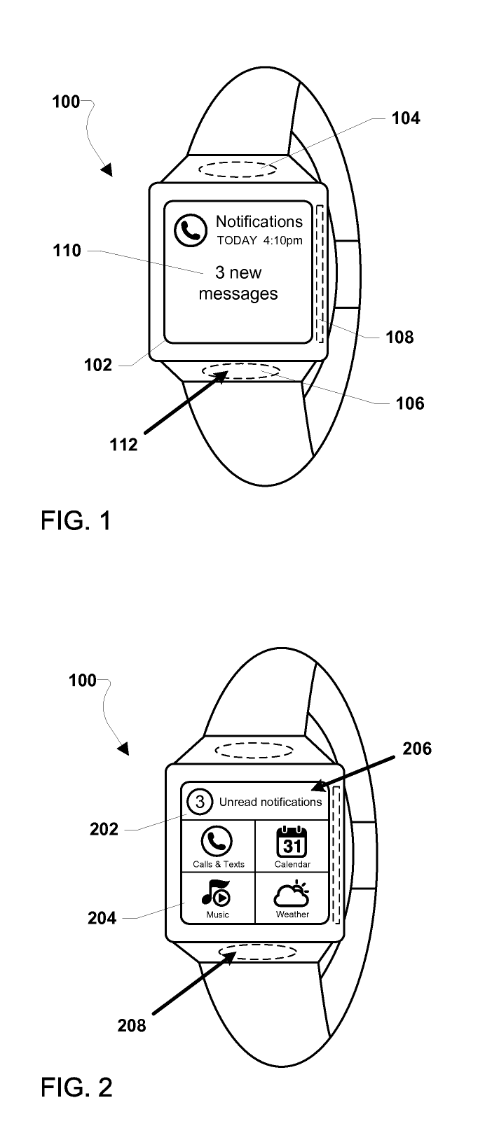

FIGS. 1-11 illustrate embodiment displays on a small touchscreen of a computing device suitable for use with the various embodiments. The various displays illustrated in FIGS. 1-11 are examples of displays that may be presented in various states and state transitions of the computing device, particularly in response to particular inputs on a touchscreen and/or a button of the computing device. A processor of the computing device may correlate a received input with one of various commands to manage notifications received by the computing device.

FIG. 1 illustrates a computing device 100 including a touchscreen display 102, a first button 104, a second button 106, and a third button 108. A notification 110 may be displayed on the touchscreen display 102, for example, a summary notification that indicates that three message have been received by the computing device 100 since the last time notifications were managed. The summary notification 110 is merely exemplary, and the touchscreen display 102 may alternatively display a notification of a particular message or device event. The notification 110 may be displayed on substantially all of the touchscreen display 102, owing to the relatively small size of the display.

The computing device 100 may receive a user input in the form of a touch or press of one or more of the touchscreen 102, the first button 104, the second button 106, and the third button 108, and a processor of the computing device 100 may change a state of the computing device based on the received input. For example, the computing device 100 may receive a user input 112 in the form of a press of the button 106, and the input 112 may be correlated by the processor with a command to temporarily dismiss the received notifications.

FIG. 2 illustrates a display when the computing device 100 temporarily dismisses the received notifications. In an embodiment, the touchscreen display 102 may display a notification bar 202, and one or more other functions 204 of the computing device 100, such as a function to make an outgoing phone call or to send an outgoing message (e.g., email or SMS), a function to view a calendar, a function to play music, or a function to display current and/or forecasted weather. The notification bar 202 serves as an indication that one or more notifications were received by the computing device. The illustration of the notification bar 202 is not intended as a limitation, and such indication of pending notifications may be implemented in a variety of forms other than a notification bar, such as an icon, shape, or image; a scrolling, flashing, or temporarily displayed message; an audible indication of pending notifications; a steady or flashing light on the body of the computing device 100 (e.g., an LED or other light source), a vibration or other haptic feedback from the computing device, or another indication of pending notifications.

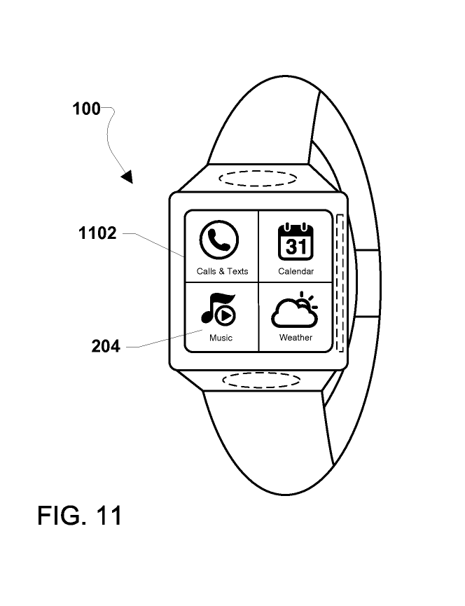

The computing device 100 may receive a user input at one or more of the touchscreen 102, and the first, second, and third buttons 104-108, and a processor of the computing device 100 may change a state of the computing device based on the received input. For example, the computing device 100 may receive a user input 208 in the form of a press of the button 106, and the processor may correlate that input 208 with a command to display a main screen without any indication of the temporarily dismissed notifications (an example of which is illustrated in FIG. 11). As another example, the computing device 100 may receive a user input 206 the form of a tap on the notification bar 202 portion of the touchscreen 102, and the processor may correlate that input 206 with a command to display one of the temporarily dismissed notifications.

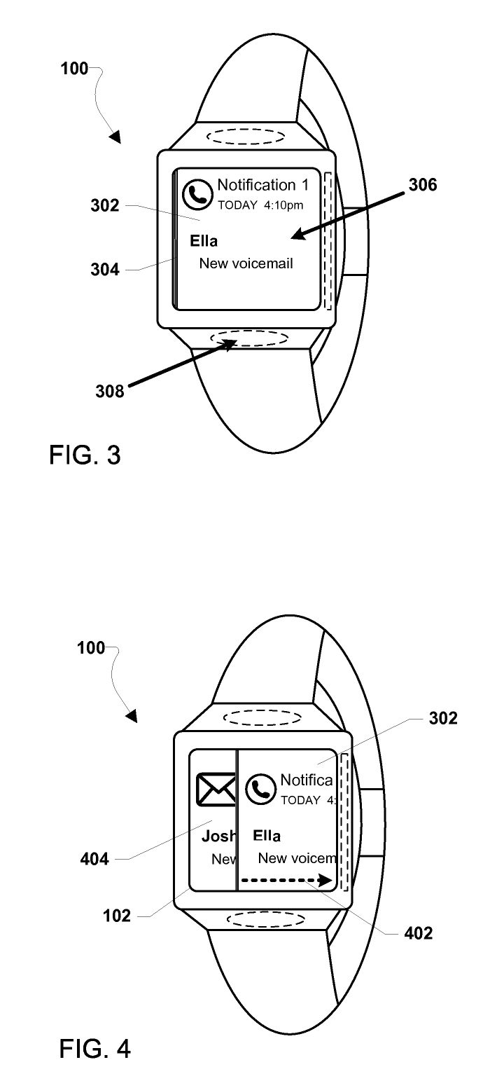

FIG. 3 illustrates a display when the computing device 100 recalls the temporarily dismissed notifications. The touchscreen display 102 may display a notification 302. The notification 302 may be displayed on substantially all of the touchscreen display 102. The notification may include an indication 304 that the notification 302 may be interacted with in various ways. For example, the indication 304 illustrated in FIG. 3 is implemented as a relatively thicker border on the left side of the notification 302, but in some embodiments other visual indications may be used.

The notification 302 may be associated with an application running on the computing device 100 or on another device with which the device 100 is in communication, such as a smartphone or other similar device. The notification 302 may indicate that a voice message is waiting, and may indicate a caller identity, a time that the voice message was recorded, and/or other information related to the voice message or the associated application.

From this state the processor of the computing device 100 may change a state of the computing device based on a received user input. For example, the computing device 100 may receive a user input 308 in the form of a press of the button 106, and the processor may correlate that input 308 with a command to temporarily dismiss the notifications. When the notifications are temporarily dismissed, the notifications may be retained in a memory of the computing device 100, and the touchscreen display 102 may display an indication that temporarily dismissed notifications remain in memory, such as illustrated in FIG. 2. As another example, the computing device 100 may receive a user input 306 the form of a tap on the notification 302 displayed on the touchscreen 102, and the processor may correlate that input 306 with a command to launch an application associated with the notification and/or permanently dismiss the notification. For example, the processor may launch a phone application associated with the voice message notification and may permanently dismiss the notification. In some embodiments, the processor may further initiate a phone call to retrieve the waiting voice message.

FIG. 4 illustrates a display when the computing device 100 permanently dismisses a notification. For example, the computing device 100 may receive a user input 402 in the form of a tap, touch or swipe on the touchscreen 102. The input 402 is illustrated in FIG. 4 as a swipe across the notification 302, but the input may include another input, such as a button press, a double tap, or a long press, and/or a combination of other inputs. The processor may correlate that input 402 with a command to permanently dismiss the notification 302. The processor may remove or delete a permanently dismissed notification from memory, and the processor may change any indication of remaining notifications (e.g., the notification bar 202) to no longer indicate the permanently dismissed notification.

In some embodiments, when more than one notification is stored in memory, permanently dismissing a first notification (e.g., the notification 302) may reveal or cause to be displayed a second notification (e.g., a notification 404). In some embodiments, notifications may each be displayed on substantially all of the touchscreen display 102, and the processor of the computing device 100 may be configured to cause each notification to behave as if the notifications were a series of stacked images. For example, when the input 402 includes a swipe (e.g., a left-to-right swipe), the processor may control the first notification 302 to slide in the direction of the swipe (i.e., from left to right), and the processor may further display portions of the second notification 404 (e.g., to the left of the thickened border 304) as the first notification 302 slides. Thus, in some embodiments, the display of notifications and their response to user inputs may mimic the behavior of a stacked deck of cards.

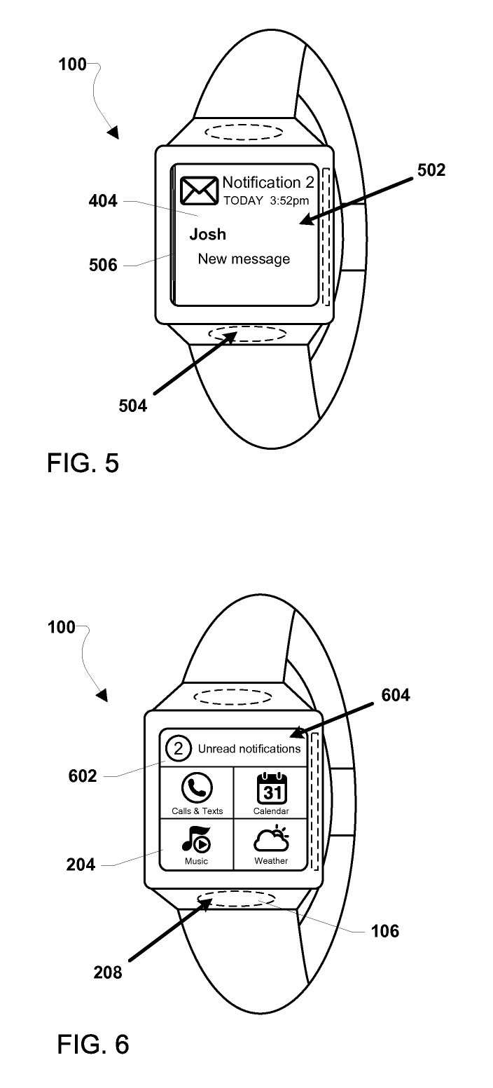

FIG. 5 illustrates a display of the second notification 404 on the touchscreen display 102. The second notification 404 may be displayed on substantially all of the touchscreen display 102. The second notification may include an indication 506 that the second notification may be interacted with in various ways. For example, the indication 506 illustrated in FIG. 5 is implemented as a relatively thicker border on the left side of the notification 404, but in some embodiments other visual indications may be used. The notification 404 may be associated with an application running on the computing device 100 or on another device with which the device 100 is in communication, such as a smartphone or other similar device. The notification 404 may indicate that a text message or email message has arrived, and may indicate a sender identity, a time that the message arrived, and/or other information related to the message or the associated application. A processor of the computing device 100 may change a state of the computing device based on a received input. For example, the computing device 100 may receive a user input 502 in the form of a tap on the touchscreen 102 on the notification 404, and the processor may correlate that input 502 with a command to launch an application associated with the notification and/or permanently dismiss the notification. For example, the processor may launch an email application or a messaging application associated with the voice message notification and may permanently dismiss the notification.

As another example, the computing device 100 may receive a user input 504 in the form of a press of the button 106, and the processor may correlate that input 504 with a command to temporarily dismiss the remaining notifications. When the remaining notifications are temporarily dismissed, the remaining notifications may be retained in a memory of the computing device 100, and the touchscreen display 102 may display an indication that temporarily dismissed notifications remain in memory, such as illustrated in FIG. 6.

FIG. 6 illustrates a display when the computing device 100 temporarily dismisses the remaining notifications. In an embodiment, the touchscreen display 102 may display a notification bar 602, and one or more other functions 204 of the computing device 100. The notification bar 602 serves as an indication that one or more temporarily dismissed notifications remain in memory (e.g., two remaining notifications, since the notification 302 was permanently dismissed). The illustration of the notification bar 602 is not intended as a limitation, and such indication of pending notifications may be implemented in a variety of forms other than a notification bar, such as an icon, shape, or image; a scrolling, flashing, or temporarily displayed message; an audible indication of pending notifications; a steady or flashing light on the body of the computing device 100 (e.g., an LED or other light source), a vibration or other haptic feedback from the computing device, or another indication of pending notifications. A processor of the computing device 100 may change a state of the computing device based on a user input received in the form of a tap or swipe of the touchscreen 102 or a press of a button 104-108 of the computing device. For example, the computing device 100 may receive the user input 208 in the form of a press of the button 106, and the processor may correlate that input 208 with a command to display a main screen without any indication of the temporarily dismissed notifications. As another example, the computing device 100 may receive a user input 604 in the form of a tap on the touchscreen 102 on the notification bar 602, and the processor may correlate that input 604 with a command to display one of the remaining temporarily dismissed notifications.

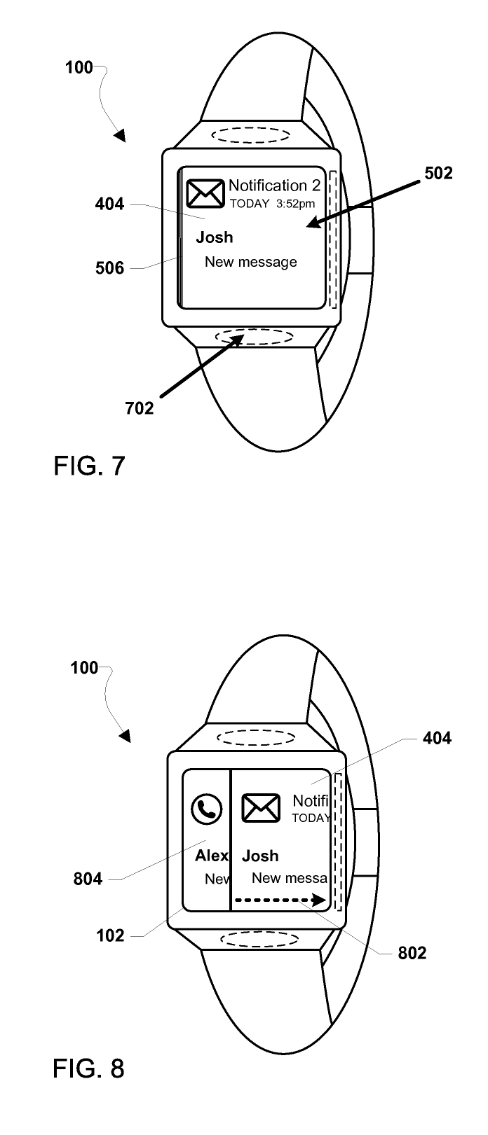

FIG. 7 illustrates a display when the computing device 100 recalls the remaining temporarily dismissed notifications. The touchscreen display 102 may display the second notification 404 on the touchscreen display 102. The notification 404 may be displayed on substantially all of the touchscreen display 102. The notification 404 may be associated with an application running on the computing device 100 or on another device with which the device 100 is in communication, such as a smartphone or other similar device. A processor of the computing device 100 may change a state of the computing device based on a received input. For example, the computing device 100 may receive a user input 502 in the form of a tap on the touchscreen 102 on the notification 404, and the processor may correlate that input 502 with a command to launch an application associated with the notification and/or permanently dismiss the notification. For example, the processor may launch an email application or a messaging application associated with the voice message notification and may permanently dismiss the notification.

As another example, the computing device 100 may receive a user input 702 in the form of a press of the button 106, and the processor may correlate that input 702 with a command to temporarily dismiss the remaining notifications. When the remaining notifications are temporarily dismissed, the remaining notifications may be retained in a memory of the computing device 100, and the touchscreen display 102 may display an indication that temporarily dismissed notifications remain in memory, such as the notification bar 602 illustrated in FIG. 6.

FIG. 8 illustrates a display when the computing device 100 permanently dismisses the second notification. For example, the computing device 100 may receive a user input 802 in the form of a tap on the touchscreen 102. The input 802 is illustrated in FIG. 8 as a swipe across the second notification 404, but the input 802 may include another input, such as a button press, a double tap, or a long press, and/or a combination of other inputs. The processor may correlate that input 802 with a command to permanently dismiss the second notification 404. A permanently dismissed notification may no longer be stored in memory, and any indication of it on another screen (e.g., the notification bar 602) may be changed to no longer indicate the permanently dismissed notification.

In some embodiments, when more than one notification remains in memory, permanently dismissing the second notification 404 may reveal or cause to be displayed a third notification 804. In some embodiments, notifications may each be displayed on substantially all of the touchscreen display 102, and the processor of the computing device 100 may be configured to cause each notification to behave as if the notifications were a series of stacked images. For example, when the input 802 includes a swipe (e.g., a left-to-right swipe), the processor may control the second notification 404 to slide in the direction of the swipe (i.e., from left to right), and the processor may further display portions of the third notification 804 (e.g., to the left of the thickened border 506) as the second notification 404 slides.

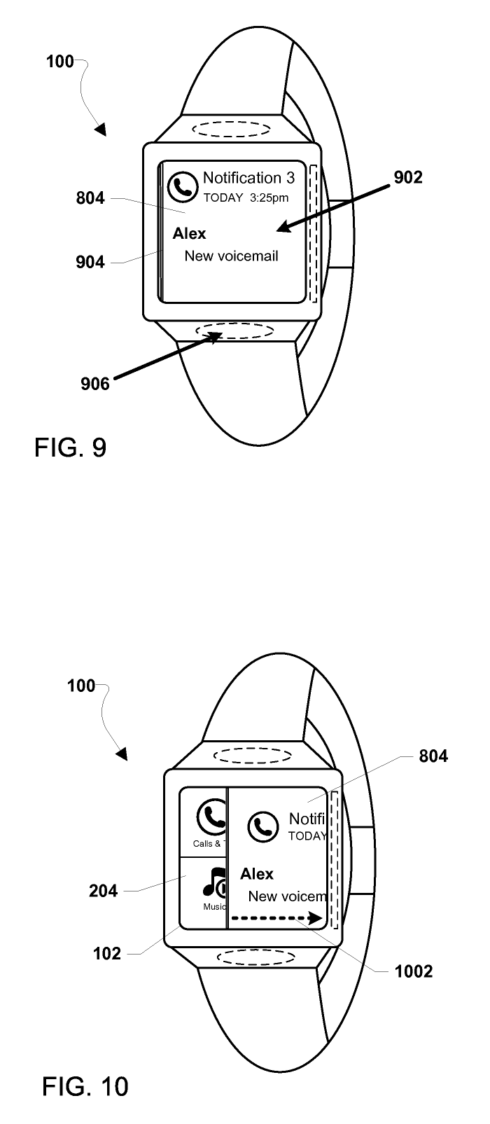

FIG. 9 illustrates a display of the third notification 804 on the touchscreen display 102. The third notification 804 may be displayed on substantially all of the touchscreen display 102. The notification 804 may be associated with an application running on the computing device 100 or on another device with which the device 100 is in communication, such as a smartphone or other similar device. The notification 804 may indicate that a voice message is waiting, and may indicate a caller identity, a time that the voice message was recorded, and/or other information related to the voice message or the associated application. A processor of the computing device 100 may change a state of the computing device based on a received input. For example, the computing device 100 may receive a user input 902 in the form of a tap on the touchscreen 102 on the notification 804, and the processor may correlate that input 902 with a command to launch an application associated with the notification and/or permanently dismiss the notification. For example, the processor may launch a phone application associated with the voice message notification and may permanently dismiss the notification. In some embodiments, the processor may further initiate a phone call to retrieve the waiting voice message.

As another example, the computing device 100 may receive a user input 906 in the form of a press of the button 106, and the processor may correlate that input 906 with a command to temporarily dismiss the remaining notifications. When the remaining notifications are temporarily dismissed, the remaining notifications may be retained in a memory of the computing device 100, and the touchscreen display 102 may display an indication that temporarily dismissed notifications remain in memory, such as illustrated in FIGS. 2 and 6.

FIG. 10 illustrates a display when the computing device 100 permanently dismisses the third notification 404. For example, the computing device 100 may receive a user input 1002 in the form of a tap or swipe on the touchscreen 102. The input 1002 is illustrated in FIG. 10 as a swipe across the third notification 804, but the input 1002 may include another input, such as a button press, a double tap, or a long press, and/or a combination of other inputs. The processor may correlate that input 1002 with a command to permanently dismiss the third notification 804. A permanently dismissed notification may no longer be stored in memory, and any indication of it on another screen (e.g., the notification bar 602) may be changed to no longer indicate the permanently dismissed notification.

In some embodiments, when no more notifications remain in memory, permanently dismissing the third notification 804 may reveal or cause to be displayed a main screen allowing access to other functions 204 of the computing device 100. In some embodiments, notifications may each be displayed on substantially all of the touchscreen display 102, and the processor of the computing device 100 may be configured to cause each notification to behave as if the notifications were a series of stacked images. For example, when the input 1002 includes a swipe (e.g., a left-to-right swipe), the processor may control the third notification 804 to slide in the direction of the swipe (i.e., from left to right), and the processor may further display portions of the main screen (e.g., to the left of the thickened border 904) as the third notification 804 slides.

FIG. 11 illustrates a display of a main screen 1102 enabling access to other functions 204 of the computing device. In an embodiment, the main screen 1102 may not include a notification bar or another indication of the permanently dismissed notifications. In the event that a new notification is received, the processor of the computing device 100 may control the touchscreen display to show a notification screen (e.g., similar to that illustrated in FIGS. 1, 3, 5, 7, and 9) or an indication that a new notification has arrived together with other functions of the computing device (e.g., similar to that illustrated in FIGS. 2 and 6).

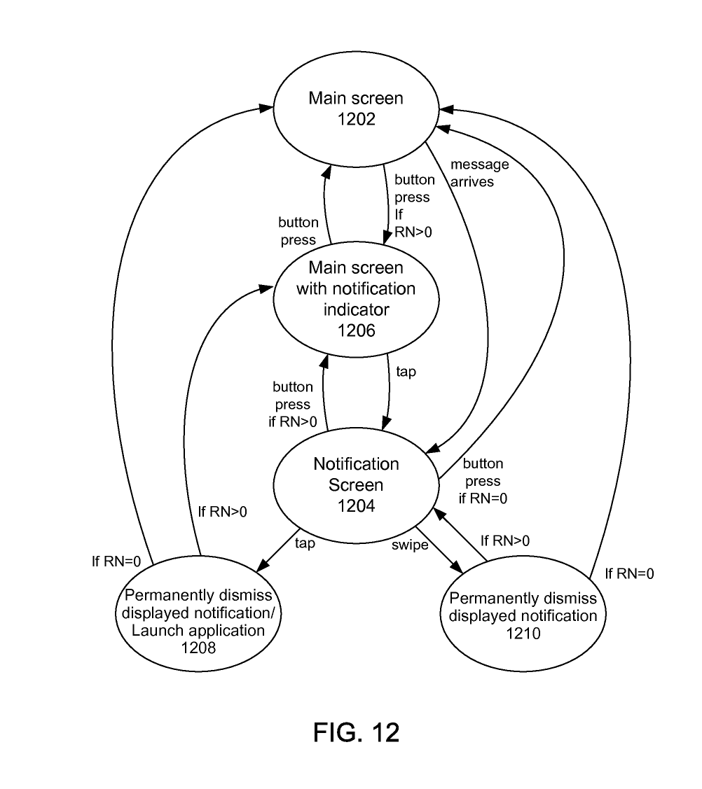

FIG. 12 is a state diagram illustrating states and state transitions of the computing device 100 according to an embodiment. A touchscreen display of the computing device may display a main screen in state 1202 (e.g., the main screen 1102) that does not include an indication of any notification. When a message arrives (e.g., an email, a text message, or a voice message waiting indicator), a processor of the computing device may transition the computing device to display a notification screen in state 1204 (e.g., notification 110).

The processor of the computing device may correlate various inputs with various commands to manage notifications on the computing device. The specific inputs described below are merely examples used for clarity of explanation, and other specific inputs may be correlated with the described commands, actions, or state transitions. For example, when the computing device in state 1204 receives a user input to temporarily dismiss the displayed notification (such as a button press), and there is at least one notification remaining in memory (i.e., remaining notifications (RN)>0), the processor may temporarily dismiss the notification(s) and transition the computing device to display a main screen with a notification indicator in state 1206 (e.g., the notification bar 202 and the other functions 204).

When the computing device in state 1204 receives a user input to interact with the displayed notification (such as a tap on the displayed notification), the processor of the computing device may transition the computing device to permanently dismiss the notification and launch an application associated with the notification in state 1208.

When the computing device in state 1204 receives a user input to permanently dismiss the displayed notification (such as a swipe across the displayed notification), the processor of the computing device may permanently dismiss the displayed notification in state 1210. When the computing device in state 1204 receives a user input (such as a button press), and there are no notifications remaining in memory (i.e., RN=0), the processor may display the main screen in state 1202.

The computing device may display a main screen with a notification indicator in state 1206 when notification(s) remain in memory. Notification(s) may remain in memory when they have been temporarily dismissed, or when they have newly arrived at the computing device. When the computing device in state 1206 receives a user input (such as a button press), the processor may display the main screen in state 1202. When the computing device in state 1206 receives a user input to invoke the notification (such as a tap on the notification indicator or another interaction with the notification indicator), the processor may display the notification screen in state 1204.

The processor of the computing device may launch an application associated with the notification from state 1204. When an action or event within the launched application is complete, or when the application is closed, if no notifications remain in memory (i.e., RN=0), the processor of the computing device may display the main screen in state 1202. When an action or event within the launched application is complete, or when the application is closed, if notification(s) remain in memory (i.e., RN>0), the processor of the computing device may display the main screen with a notification indicator in state 1206.

When the computing device in state 1204 receives a user input to permanently dismiss the displayed notification (such as a swipe across the displayed notification), the processor of the computing device may permanently dismiss the displayed notification in state 1210. If no notifications remain in memory (i.e., RN=0) when the displayed notification is permanently dismissed, the processor may display the main screen in state 1202. When the displayed notification is permanently dismissed and notification(s) remain in memory (i.e., RN>0), the processor may display the notification screen in state 1204.

In some embodiments, when the computing device displays the main screen in state 1202 and receives a user input, such as a button press and notification(s) remain in memory, the processor of the computing device may display the main screen with the notification indicator in state 1206.

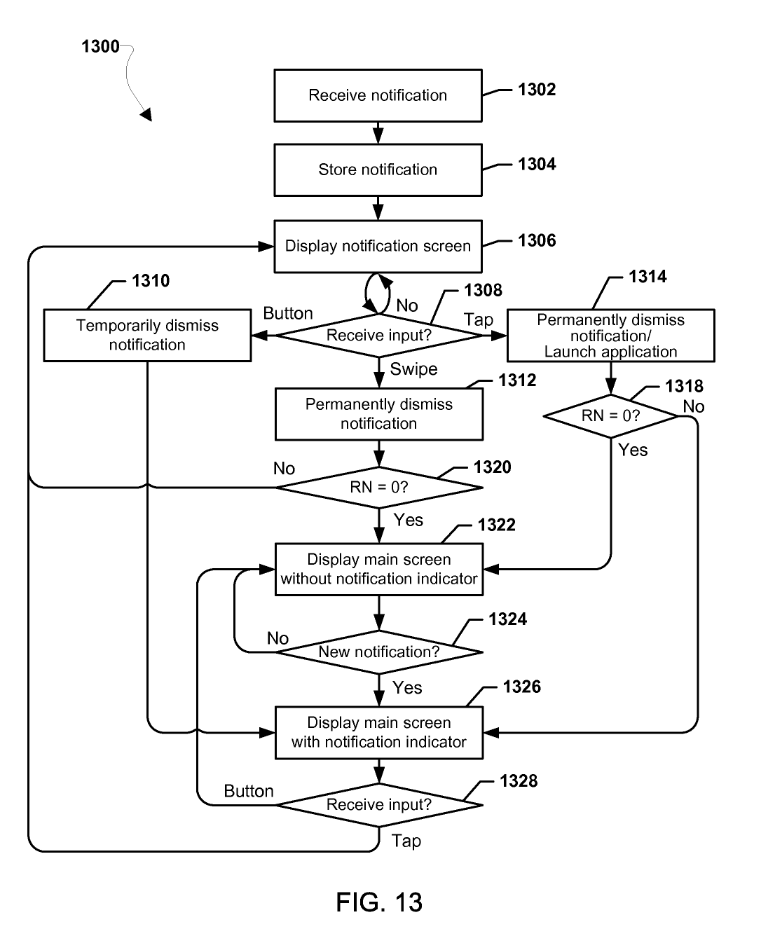

FIG. 13 is a process flow diagram illustrating an embodiment method 1300 for managing notifications on a small touchscreen of a device. The specific inputs described below, such as button presses, swipes, and taps, are merely examples used for clarity of explanation, and other specific inputs received by the computing device may be correlated with the described commands and/or actions.

In block 1302, a computing device (e.g., computing device 100) may receive a notification, and in block 1304 a processor of the computing device may store the notification in a memory of the computing device. In block 1306, a processor of the computing device may display a notification screen indicating the arrival of the notification. The displayed notification may be displayed on substantially all of the touchscreen display.

In determination block 1308, the processor may determine whether the computing device receives a user input to temporarily dismiss the displayed notification. In response to receiving a user input to temporarily dismiss the displayed notification, e.g., a button press, (i.e., determination block 1308=“Button”), the processor may temporarily dismiss the displayed notification in block 1310. When the displayed notification is temporarily dismissed, the processor may control the computing device to display a main screen with a notification indicator in block 1326.

In response to receiving a user input to permanently dismiss the displayed notification, e.g. a swipe across the notification on the touchscreen display, (i.e., determination block 1308=“Swipe”), the processor may permanently dismiss the displayed notification in block 1312. In determination block 1320, the processor may determine whether any notifications remain in memory. In response to determining that one or more notifications remain in memory (i.e., determination block 1320=“No”), the processor may control the computing device to display the notification screen in block 1306, and the processor may display the next remaining notification. In response to determining that no notifications remain in memory (i.e., determination block 1320=“Yes”), the processor may display a main screen without a notification indicator in block 1322.

In response to receiving a user input to interact with the displayed notification, e.g. a tap on the displayed notification on the touchscreen display, (i.e., determination block 1308=“Tap”), the processor may permanently dismiss the displayed notification and launch an application associated with the notification in block 1314. When the application is closed, or an action or event associated with the application for which the notification was displayed is completed or dismissed, the processor may determine whether any notifications remain in memory in determination block 1318.

In response to determining that no notifications remain in memory (i.e., determination block 1318=“Yes”), the processor may display a main screen without a notification indicator in block 1322. In response to determining that one or more notifications remain in memory (i.e., determination block 1318=“No”), the processor may display a main screen with a notification indicator in block 1326.

In determination block 1324, the processor may determine whether a new notification is received while the main screen is displayed without the notification indicator. As long as no new notification are received, the processor may display the main screen without the notification indicator (i.e., determination block 1324=“No”). In response to receiving a new notification (i.e., determination block 1324=“Yes”), the processor may display the main screen with the notification indicator in block 1326.

In determination block 1328, while the main screen is displayed with the notification indicator, the processor may determine whether a user input is received, e.g. in the form of a tap on a touchscreen display and/or a press of a button of the computing device. In response to receiving a user input to dismiss the notification indicator, e.g., in the form of a press of a button of the computing device (i.e., determination block 1328=“Button”), the processor may display the main screen without the notification indicator in block 1322. In such case, the processor may retain any remaining notifications in memory. In response to receiving a user input to invoke the remaining notifications, such as a tap on the displayed notification bar, (i.e., determination block 1328=“Tap”), the processor may display the notification screen in block 1306), and the processor may recall the temporarily dismissed notification(s) and display a notification on substantially all of the touchscreen display.

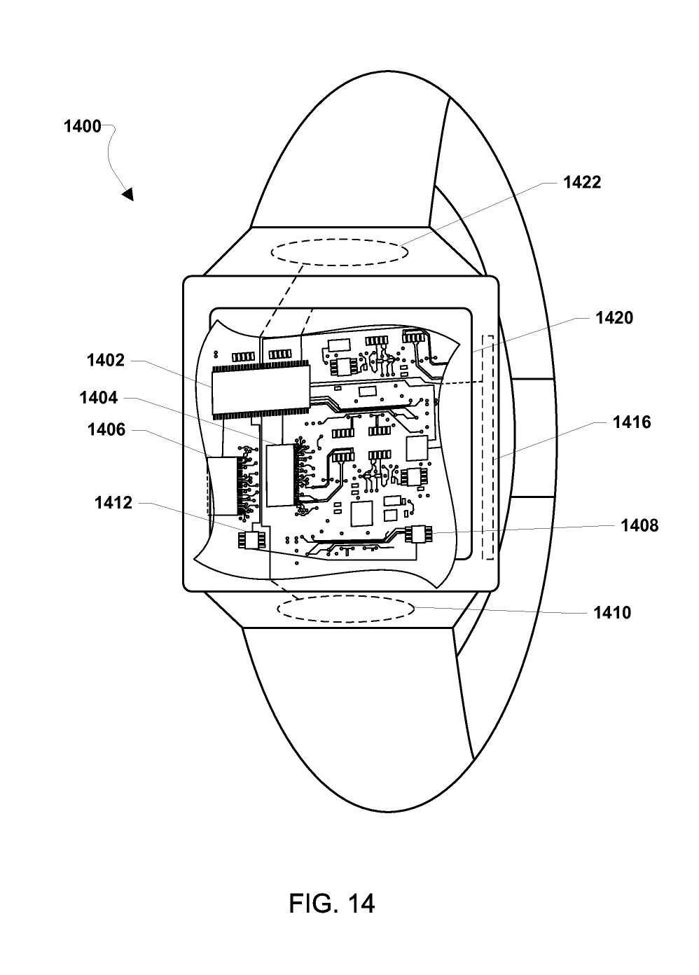

The various embodiments may be implemented within a variety of computing devices, such as a wearable computing device. FIG. 14 illustrates an example wearable computing device in the form of a smart watch 1400. A smart watch 1400 may include a processor 1402 coupled to internal memories 1404 and 1406. Internal memories 1404 and 1406 may be volatile or non-volatile memories, and may also be secure and/or encrypted memories, or unsecure and/or unencrypted memories, or any combination thereof. The processor 1402 may also be coupled to a touchscreen display 1420, such as a resistive-sensing touchscreen, capacitive-sensing touchscreen infrared sensing touchscreen, or the like. Additionally, the smart watch 1400 may have one or more antenna 1408 for sending and receiving electromagnetic radiation that may be connected to one or more wireless data links 1412, such as one or more Bluetooth® transceivers, Peanut transceivers, Wi-Fi transceivers, ANT+ transceivers, etc., which may be coupled to the processor 1402. The smart watch 1400 may also include physical virtual buttons 1422 and 1410 for receiving user inputs as well as a slide sensor 1416 for receiving user inputs.

The processor 1402 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in an internal memory before they are accessed and loaded into the processor 1402. The processor 1402 may include internal memory sufficient to store the application software instructions. In many devices the internal memory may be a volatile or nonvolatile memory, such as flash memory, or a mixture of both. For the purposes of this description, a general reference to memory refers to memory accessible by the processor 1402 including internal memory or removable memory plugged into the mobile device and memory within the processor 1402 itself.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the various embodiments. Thus, the various embodiments are not intended to be limited to the embodiments shown herein but is to be accorded the widest scope consistent with the following claims and the principles and novel features disclosed herein.

What is claimed is:

1. A method for managing notifications on a small touchscreen of a computing device, comprising:
displaying a first notification of a plurality of notifications on substantially all of the small touchscreen of the computing device;
temporarily dismissing the plurality of notifications when a first user input is received by the computing device;
recalling the plurality of notifications and displaying the first notification on substantially all of the small touchscreen of the device when a second user input is received by the computing device;
permanently dismissing the first notification when a third user input is received by the computing device; and
displaying a second notification of the plurality of notifications on substantially all of the small touchscreen of the device when the first notification is permanently dismissed.

2. The method of claim 1, wherein temporarily dismissing the plurality of notifications comprises retaining the plurality of notifications in a memory of the computing device.

3. The method of claim 2, wherein temporarily dismissing the plurality of notifications comprises enabling access to another function of the computing device on substantially all of the small touchscreen of the computing device.

4. The method of claim 1, wherein displaying a second notification of the plurality of notifications on substantially all of the small touchscreen of the computing device when the first notification is permanently dismissed comprises displaying a decreasing portion of the first notification and an increasing portion of the second notification on substantially all of the small touchscreen of the computing device when the first notification is permanently dismissed.

5. The method of claim 1, wherein the computing device comprises a wrist-worn display.

6. A computing device, comprising:
a processor configured with processor-executable instructions to perform operations comprising:
displaying a first notification of a plurality of notifications on substantially all of a small touchscreen of the computing device;
temporarily dismissing the plurality of notifications when a first user input is received by the computing device;
recalling the plurality of notifications and displaying the first notification on substantially all of the small touchscreen of the device when a second user input is received by the computing device;
permanently dismissing the first notification when a third user input is received by the computing device; and
displaying a second notification of the plurality of notifications on substantially all of the small touchscreen of the device when the first notification is permanently dismissed.

7. The computing device of claim 6, wherein the processor is configured with processor-executable instructions to perform operations such that temporarily dismissing the plurality of notifications comprises retaining the plurality of notifications in a memory of the computing device.

8. The computing device of claim 7, wherein the processor is configured with processor-executable instructions to perform operations such that temporarily dismissing the plurality of notifications comprises enabling access to another function of the computing device on substantially all of the small touchscreen of the computing device.

9. The computing device of claim 6, wherein the processor is configured with processor-executable instructions to perform operations such that displaying a second notification of the plurality of notifications on substantially all of the small touchscreen of the computing device when the first notification is permanently dismissed comprises displaying a decreasing portion of the first notification and an increasing portion of the second notification on substantially all of the small touchscreen of the computing device when the first notification is permanently dismissed.

10. The computing device of claim 6, wherein the computing device comprises a wrist-worn display.

11. A non-transitory processor-readable storage medium having stored thereon processor-executable software instructions configured to cause a processor to perform operations for managing notifications on a small touchscreen of a computing device comprising:
displaying a first notification of a plurality of notifications on substantially all of the small touchscreen of the computing device;
temporarily dismissing the plurality of notifications when a first user input is received by the computing device;
recalling the plurality of notifications and displaying the first notification on substantially all of the small touchscreen of the device when a second user input is received by the computing device;
permanently dismissing the first notification when a third user input is received by the computing device; and
displaying a second notification of the plurality of notifications on substantially all of the small touchscreen of the device when the first notification is permanently dismissed.

12. The non-transitory processor-readable storage medium of claim 11, wherein the stored processor-executable software instructions are configured to cause a processor to perform operations such that temporarily dismissing the plurality of notifications comprises retaining the plurality of notifications in a memory of the computing device.

13. The non-transitory processor-readable storage medium of claim 12, wherein the stored processor-executable software instructions are configured to cause a processor to perform operations such that temporarily dismissing the plurality of notifications comprises enabling access to another function of the computing device on substantially all of the small touchscreen of the computing device.

14. The non-transitory processor-readable storage medium of claim 11, wherein the stored processor-executable software instructions are configured to cause a processor to perform operations such that displaying a second notification of the plurality of notifications on substantially all of the small touchscreen of the computing device when the first notification is permanently dismissed comprises displaying a decreasing portion of the first notification and an increasing portion of the second notification on substantially all of the small touchscreen of the computing device when the first notification is permanently dismissed.

15. The non-transitory processor-readable storage medium of claim 11, wherein the computing device comprises a wrist-worn display.

16. A computing device, comprising:
means for displaying a first notification of a plurality of notifications on substantially all of the small touchscreen of the computing device;
means for temporarily dismissing the plurality of notifications when a first user input is received by the computing device;
means for recalling the plurality of notifications and displaying the first notification on substantially all of the small touchscreen of the device when a second user input is received by the computing device;
means for permanently dismissing the first notification when a third user input is received by the computing device; and
means for displaying a second notification of the plurality of notifications on substantially all of the small touchscreen of the device when the first notification is permanently dismissed.

17. The computing device of claim 16, wherein means for temporarily dismissing the plurality of notifications comprises means for retaining the plurality of notifications in a memory of the computing device.

18. The computing device of claim 17, wherein means for temporarily dismissing the plurality of notifications comprises means for enabling access to another function of the computing device on substantially all of the small touchscreen of the computing device.

19. The computing device of claim 16, wherein means for displaying a second notification of the plurality of notifications on substantially all of the small touchscreen of the computing device when the first notification is permanently dismissed comprises means for displaying a decreasing portion of the first notification and an increasing portion of the second notification on substantially all of the small touchscreen of the computing device when the first notification is permanently dismissed.

20. The computing device of claim 16, wherein the computing device comprises a wrist-worn display.
